(19) United States
(12) Patent Application Publication
(10) Pub. No.: US 2003/0051106 A1
(43) Pub. Date: Mar. 13, 2003

(54) Multi-memory architecture and access controller therefor

(76) Inventors: Ching-Fang Yen, Taipei Hsien (TW); Sheau-Yung Shyu, Hsinchu (TW); Ful-Long Ni, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/064,916

(22) Filed: Aug. 29, 2002

(30) Foreign Application Priority Data
Sep. 4, 2001 (TW) 90121825

(51) Int. Cl. G06F 12/00

(52) U.S. Cl. 711/154; 711/159

(57) ABSTRACT

A multi-memory architecture and a memory access controller therefor are proposed. The multi-memory architecture is composed of at least two different types of memory devices and is used to provide a specific externally-accessible data storage capacity. The multi-memory architecture comprises a first memory device and a second memory device; wherein the first memory device has a first data storage capacity; and the second memory device has a second data storage capacity. The pin configuration of the multi-memory architecture is compatible with the first memory device with the externally accessible data storage capacity, wherein the externally-accessible data storage capacity can be either the first data storage capacity, the second data storage capacity, or the sum of the first and second data storage capacties.

### CROSS REFERENCE TO RELATED APPLICATIONS

This application claims the priority benefit of Taiwan application serial no. 90121825, filed Sep. 4, 2001.

### BACKGROUND OF INVENTION

1. Field of the Invention

The present invention generally relates to computer memory technology, and more particularly, to a multi-memory architecture composed of at least two different types of memory devices, and further relates to a memory access controller for this multi-memory architecture.

2. Description of Related Art

Flash memory is a type of nonvolatile memory, which is widely utilized in various kinds of intelligent electronic devices such as mobile phones and PDA“s (Personal Digital Assistant) to serve as a compact data storage unit for storing program codes and data including text, images, video/audio, and personal information such as addresses and telephone numbers. Since program codes and associated data are typically fixed in length and small in quantity, it would be a cost-ineffective practice to use high-density flash memory to store program codes and data. To improve cost-effectiveness, the flash memory is typically reserved for storing those application data that are small in quantity such as personal information. Therefore, the memory in mobile phones is preferably a combined multi-memory architecture composed of a flash memory and a Mask ROM (Read-Only Memory).

Another type of multi-memory architecture includes a flash memory and an SRAM (Static Random-Access Memory). These two memory devices are enclosed in the same package to serve as a single memory unit. This multi-memory architecture is designed in such a manner that the flash memory and-the SRAM share a common set of address and data buses but each having its own control buses and power buses. Because of this architecture, the pin configuration of the overall package is different from the pin configuration of either the flash memory or the SRAM so that the printed circuit board (PCB) used for mounting the package of this multi-memory architecture needs to be redesigned.

In conclusion, the conventional multi-memory architecture has the following drawbacks.

First, it creates a compatibility problem in the overall pin configuration, which requires a new pin layout scheme on the PCB used for mounting the package of the multi-memory architecture rather than using existing pin layout scheme of the flash memory.

Second, due to the different control buses and power buses for the two different memory devices in the multi-memory architecture, the software control codes have to be rewritten to control the combined architecture of the flash memory and the SRAM.

### SUMMARY OF INVENTION

It is therefore an objective of this invention to provide a multi-memory architecture which is composed of at least two memory devices, whose overall pin configuration is the same as the pin configuration of one of the two memory devices so that existing PCB can be used for mounting the package of the multi-memory architecture without having to redesign a new pin layout scheme on the PCB and rewrite new software control codes.

It is another objective of this invention to provide a memory access controller for the multi-memory architecture.

In accordance with the foregoing and other objectives, the invention proposes a new multi-memory architecture and a memory access controller therefor.

The present invention provides a multi-memory architecture wherein the one-time maximum accessible data storage capacity is known as the total storage capacity. The total memory of the multi-memory architecture is the same as that of a generic memory device having the same number of pins. The total number of pins refers to the all the used and unused pins of the multi-memory architecture. The multi-memory architecture of the invention is capable of providing a specific externally-accessible data storage capacity based on a predefined pin configuration including used and unused pins comprising: a first memory device having a first data storage capacity and a first predefined pin configuration having a first number of pins; and a second memory device having a second data storage capacity and a second predefined pin configuration having a second number of pins; wherein the number of first number of pins is larger than the number of second pins and the overall pin configuration of the multi-memory architecture is compatible with the first predefined pin configuration of the first memory device having the same amount of storage capacity as the multi-memory architecture.

The multi-memory architecture comprises a first memory device and a second memory device; wherein the first memory device has a first data storage capacity; and the second memory device has a second data storage capacity. The pin configuration of the multi-memory architecture is compatible with the first memory device with the externally accessible data storage capacity, wherein the externally-accessible data storage capacity can be either the first data storage capacity, the second data storage capacity, or the sum of the first and second data storage capacties.

In one preferred embodiment of the invention, the externally-accessible total data storage capacity of the multi-memory architecture is equal to the data storage capacity of the first memory device plus the data storage capacity of the second memory device.

In another preferred embodiment of the invention, the data storage capacity of the second memory device is greater than the data storage capacity of the first memory device. The second memory device includes a plurality of segments and each segment having a data storage capacity equal to the data storage capacity of the first memory device, wherein the storage space of the first memory device is used to replace any one of the segments in the second memory device so that an access to the replaced segment is mapped to the storage space of the first memory device. Furthermore, the second memory device includes at least one replacement segment, whose data storage capacity equals to each segment in the second memory device, which can be used to replace any one of the segments in the second memory device other than the segment being currently replaced by the first memory device. Furthermore, the multi-memory architecture comprises a second memory replacement segment, wherein each second memory replacement segment can replace the above segment to allow the multi-memory architecture to access the first memory device to replace at least one second memory replacement segment in the segments and store the segments that have not been replaced.

In still another preferred embodiment, the multi-memory architecture of the invention further comprises a replacement memory area, whose data storage capacity equals to the second memory device, which is partitioned into a plurality of segments each being equal in data storage capacity to the first memory device. The replacement memory area is used to replace the second memory device to allow the externally-accessible total storage space of the multi-memory architecture to cover the currently-accessed memory device selected from the second memory device excluding the storage space of the segment currently being replaced by the first memory device.

In still another preferred embodiment, the multi-memory architecture of the invention further comprising a replacement memory area and a second memory device with at least one second memory replacement segment. The second memory device further includes a plurality of replacement segments, each being equal in data storage capacity to each segment in the currently-accessed memory device, which can be used to replace any one of the segments in the currently-accessed memory device (the term “currently-accessed memory device” refers to one of the first memory device and the replacement memory area that is currently being selected) other than the segment currently being replaced by the first memory device. This allows access to the multi-memory architecture to cover the replacement segments in the second memory device and the segments in the currently-accessed memory device replacement memory area that are unreplaced by the first memory device and the second memory device.

In another aspect of the invention, the multi-memory architecture according to the invention comprises: a first memory device having a first data storage capacity and a second memory device having a second data storage capacity, wherein the overall pin configuration of the multi-memory architecture is compatible with the pin configuration of the first memory device having the same amount of storage capacity.

The invention further relates to a memory access controller used in the foregoing multi-memory architectures with first memeory device and second memory device. This memory access controller comprises: a segment identification unit, a command identification unit, and a memory selection unit. The segment identification unit is capable of generating a memory-access control signal in response to an input address signal. The command identification unit is capable of generating a memory-mode signal in response to an input control signal. The memory selection unit is used to select between the two memory devices in the multi-memory architecture based on the memory-access control signal and the memory-mode signal.

In one preferred embodiment of the invention, the segment identification unit includes: a first memory address register and a first comparator. The first memory address register is used to store a set of data representative of the addresses of the first memory device; and the first comparator is capable of comparing the input address signal against the content of the first memory address register to thereby generate the memory-access control signal.

In a preferred embodiment, the foregoing memory access controller, in addition to the segment identification unit, the command identification unit, and the memory selection unit, further comprises: a replaced-segment register, a second comparator, a virtual-segment register, and a multiplexer module. The replaced-segment register is used to store the addresses of the segment in the second memory device that is to be replaced by the second memory device. The second comparator is capable of comparing the input address signal against the content of the replaced-segment register; if matched, the second comparator outputs an enable signal. The virtual-segment register is used to store the addresses of the first memory device and indicate replacement code. The multiplexer module, which is under selection control by the enable signal output from the second comparator for selectively transferring either the content of the virtual-segment register or the segment access code in the input address signal to a decoder.

Still moreover, the foregoing memory access controller further comprises: an interface circuit coupled to the first memory address register, the replaced-segment register, and the virtual-segment register for altering the content of a selected register therefrom.

In still another preferred embodiment, the memory access controller, in addition to the first memory address register, the first comparator, and the logic circuit, further comprises: a replaced-segment register, a second comparator, a swap-segment register, and a multiplexer module. The replaced-segment register is used to store the address data indicating the segment in which the second memory device is currently being replaced by the second memory device. The second comparator is capable of comparing the input address signal against the content of the replaced-segment register; if matched, the second comparator output an enable signal. The swap-segment register is used to store the address of the first memory device and a tag of a replacement memory area being swapped to replace the second memory device. The multiplexer module is under selection control by the enable signal output from the second comparator for selectively transferring either the content of the swap-segment register or the segment access code in the input address signal to a decoder.

In conclusion, the invention provides a multi-memory architecture, which utilizes a specially-designed memory access controller to integrate the respective sets of controls and power buses of the two memory devices into a single set. The invention also allows the overall pin configuration of the multi-memory architecture to be compatible with the pin configuration of one of the two memory devices so that existing PCB pin layout scheme can be used to mount the package of the multi-memory architecture without having to redesign a new pin layout scheme on the PCB and rewrite new software control codes.

### BRIEF DESCRIPTION OF DRAWINGS

The invention can be more fully understood by reading the following detailed description of the preferred embodiments, with reference made to the accompanying drawings, wherein:drawingsdrawings

FIG. 1 is a block diagram of a preferred embodiment of the multi-memory architecture according to the invention;

FIG. 2 is a schematic diagram showing an example of the implementation of the multi-memory architecture according to the invention;

FIG. 3 is a block diagram showing an example of the memory access controller utilized by the multi-memory architecture according to the invention;

FIG. 4 is a circuit diagram showing an example of the memory access controller utilized by the multi-memory architecture according to the invention;

FIG. 5 is a schematic diagram showing still another example of the implementation of the multi-memory architecture according to the invention;

FIG. 6 is a circuit diagram showing an example of the memory access controller utilized by the multi-memory architecture according to the invention;

FIG. 7 is a schematic diagram showing another example of the implementation of the multi-memory architecture according to the invention;

FIG. 8 is a schematic diagram showing still another example of the implementation of the multi-memory architecture according to the invention; and

FIG. 9 is a schematic diagram showing still another example of the implementation of the multi-memory architecture according to the invention; and

FIG. 10 is a circuit diagram showing still another example of the memory access controller utilized by the multi-memory architecture according to the invention.

### DETAILED DESCRIPTION

The invention is disclosed in full details by way of several preferred embodiments in the following with reference to the accompanying drawings. It is to be noted that in the following preferred embodiments, the multi-memory architecture is composed of a flash memory and a Mask ROM. Broadly speaking, the multi-memory architecture can be composed of any types of memory devices including a first memory device and a second memory device as long as the overall pin configuration of the multi-memory architecture is comptabile to one of the memory devices. The overall pin configuration of the multi-memory architecture, including all used pins and unused pins (NC pins), is arranged to be the same as the pin configuration of any one of the two memory devices in the multi-memory architecture. These pins can be used for various purposes such as address pins, data pins, control signal pins, power pins, and ground pins. The invention is therefore not limited to the combination of a flash memory and a Mask ROM and instead can be any two different memory devices.

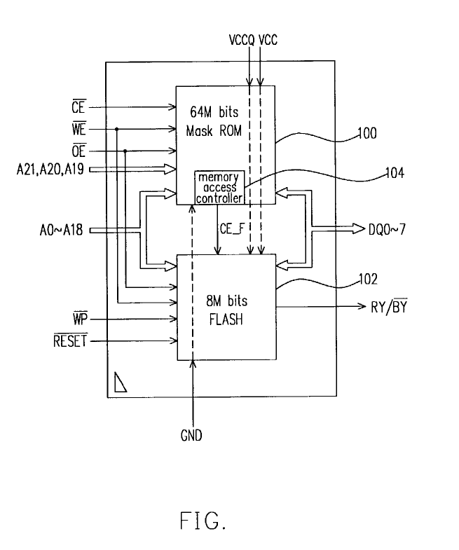

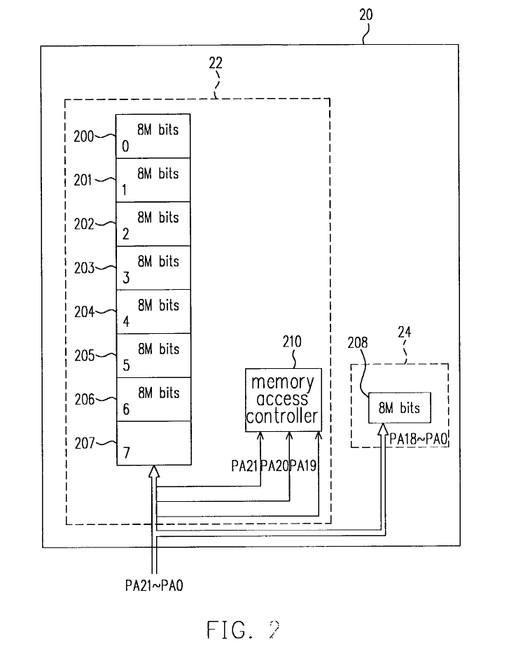

FIG. 1 is a block diagram showing a preferred embodiment of the multi-memory architecture according to the invention, which is composed of two memory devices including a 64 Mb Mask ROM 100, an 8 Mb flash memory 102, and a controller 104. In the invention, the overall pin configuration of this multi-memory architecture is arranged to be the same as the pin configuration of the generic 64 Mb flash memory for compatabitliy. A specially-designed memory access controller is used to decide from which memory device to access data. FIG. 2 is a schematic diagram showing an example of the implementation of the multi-memory architecture according to the invention (which is here designated by the reference numeral 20). As shown, this multi-memory architecture 20 is designed to provide a capacity of 64 Mb, which includes a 56 Mb Mask ROM 22, an 8 Mb flash memory 24, and a controller 210. The flash memory 24 includes a storage space 208 having a capacity of 8 Mb which is used as the partition standard for the Mask ROM 22. Thus the Mask ROM 22 is divided into eight segments 200, 201, 202, 203, 204, 205, 206, 207, each having a capacity of 8 Mb, which can be accessed by the most significant 3-bit code (PA21, PA20, PA19) in the address signal PA21-PA0. The last segment 207 serves as a virtual segment mapped to the storage space 208 of the flash memory 24. If the 3-bit code (PA21, PA20, PA19) is directed to one of the seven segments 200, 201, 202, 203, 204, 205, 206, the 3-bit code will directly gain access to the selected segment; and whereas if (PA21, PA20, PA19) is directed to the virtual segment 207, the access will be mapped to the 8 Mb storage space 208 of the flash memory 24.

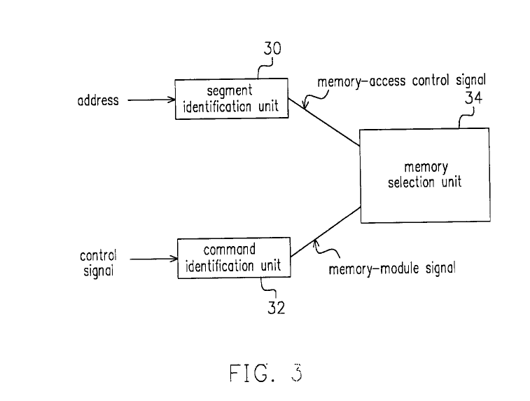

Under the new multi-memory architecture composed of two memory devices, the total capacity of the two memory devices is equal to the overall capacity of the multi-memory architecture. FIG. 3 is a circuit diagram showing an example of the memory access controller utilized by the multi-memory architecture according to the invention. As shown, the memory access controller includes: (1) a segment identification unit 30, which is capable of generating a memory-access control signal in response to an input address signal; (2) a command identification unit 32, which is capable of generating a memory-mode signal in response to an input control signal; and (3) a memory selection unit 34, which is used to select between the two memory devices in the multi-memory architecture based on the memory-access control signal and the memory-mode signal.

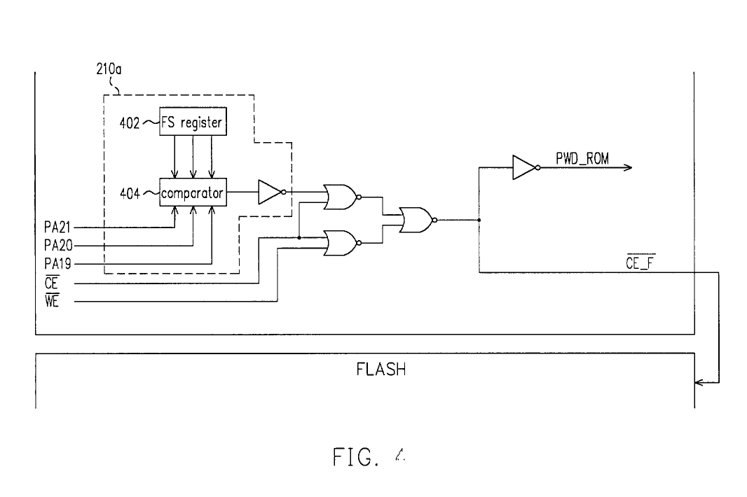

FIG. 4 is a circuit diagram showing an example of the memory access controller utilized by the multi-memory architecture according to the invention in the case of the two memory devices being a flash memory and a Mask ROM. As shown, the segment identification unit 30 shown in FIG. 3 includes: (1) a first memory address register (FS register) 402, which is used to store a set of first memory address bits used for identification of the flash memory 24. In this embodiment, the highest 3 bits in the storage space 208 of the flash memory 24 represents the set of first memory address bits; (2) a comparator 404, which is used to compare the highest 3 bits (PA21, PA20, PA19) in the input address signal against the content of the FS register 402 to thereby output the memory access signal.

The memory access controller 210a operates in such a manner that when an address signal is received, the highest 3-bit (PA21, PA20, PA19) in the address signal is compared by the comparator 404 against the 3-bit address data stored in the FS register 402. If matched and the command-enable signal CE# is at logic-LOW, the Mask ROM is disabled and the controller generates a CE_F signal (Command Enable Flash) to access to the flash memory. Whereas if the highest 3-bit (PA21, PA20, PA19) in the address signal is unmatched to the content of the FS register 402 and if CE# is at logic-LOW, the Mask ROM is accessible. In addition, when CE# and WE# are both at logic-LOW (for example when transferring the request for writing or erasing program code to the flash memory), the access to the Mask ROM is denied. In this embodiment, CE# and WE# are the control signals shown in FIG. 3.

An example will be used to depict the foregoing access operation. Assume the 3-bit address data currently stored in the FS register 402 is (1, 1, 1), then when (PA21, PA20, PA19)=(1, 1, 1), the access will be directed to the storage space 208 in the flash memory 24; otherwise, when (PA21, PA20, PA19)=(1, 1, 0), the access will be directed to the segment 206 in the Mask ROM 22. The relation of accessed segments with the input address is shown in the following table.

TABLE
(assume the content of the FS register 402 is 7 (1 1, 1))

| Input Address | Accessed Segments |
|---|---|
| 0-6 | 0-6 (Mask ROM) |
| 7 | 7 (Flash Memory) |

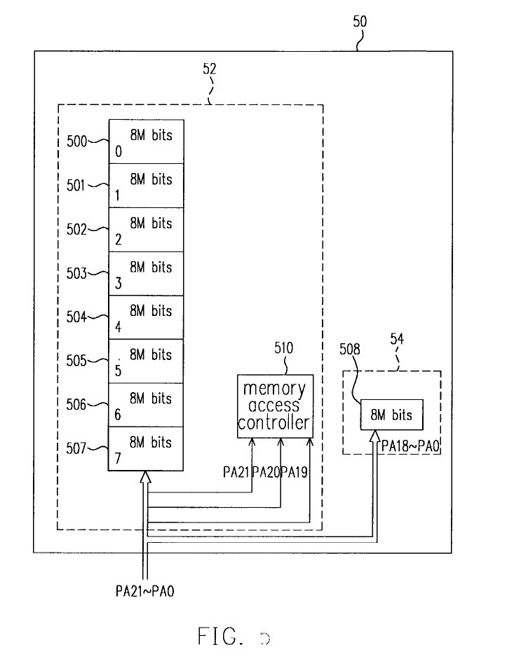

FIG. 5 is a schematic diagram showing another example of the implementation of the multi-memory architecture according to the invention (which is here designated by the reference numeral 50). Please note that the future implementation will use Flash memory and Mask Rom as example and this new multi-memory architecture will be called multi-memory architecture. As shown, this new multi-memory architecture 50 includes a 64 Mb Mask ROM 52, an 8 Mb flash memory 54, and a controller 510. In this multi-memory architecture 50, the storage space 508 of the flash memory 54 can be used to replace any segment (such as 507) in the same manner as the multi-memory architecture shown in FIG. 2. Furthermore, the replaced segment (507) can be further used to replace other segments (500-506). In the multi-memory architecture of FIG. 5, the total combined capacity of the Mask ROM and the flash memory is greater than the total accessible capacity of the multi-memory architecture so it allows the design to be more flexible.

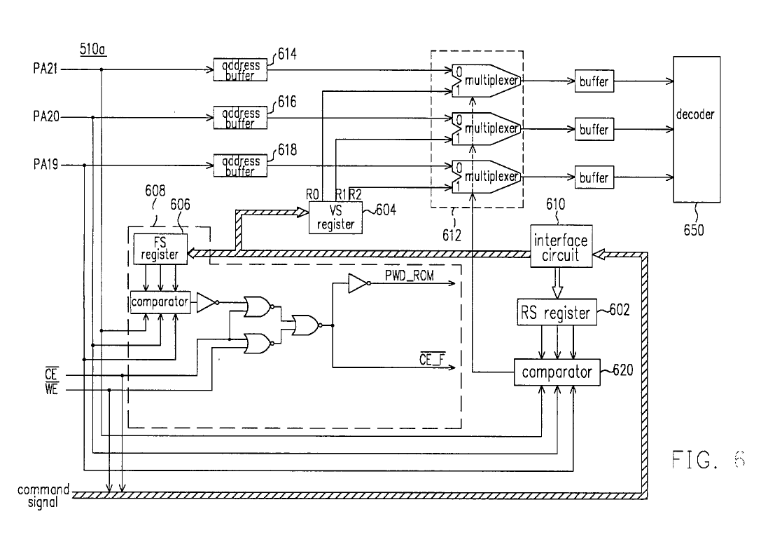

FIG. 6 is a schematic diagram showing the internal circuit architecture of the memory access controller 510 utilized by the multi-memory architecture 50 shown in FIG. 5 (which is here designated by the reference numeral 510a). As shown, the memory access controller 510a includes a circuit part 608, which is identical in architecture and function as the circuit of FIG. 4 so the description of the controller will not be repeated. The difference between the memory access controller 510 and the one shown in FIG. 4 is that it further includes: (1) a VS (Virtual Segment) register 604 for storing the most significant 3 bits in the address of the virtual segment 507, which is replaced by the flash memory's storage space 508; (2) an RS (Replaced Segment) register 602 for storing the most significant 3 bits in the address of one of the segments 500, 501, 502, 503, 504, 505, 506 that is to be replaced by the virtual segment 507; (3) an interface circuit 610, which is capable of altering the contents of the FS register 606, the RS register 602, and the VS register 604; (4) a multiplexer module 612 including three multiplexers, which are used to selectively transfer either the content of the VS register 604 or the 3-bit segment access code (PA21, PA20, PA19) in the input address signal to the decoder 650. Further, since the FS register and the VS register store the same data, i.e., the most significant 3 bits in the address of the storage space 507, one single register can be used to serve as both a FS and a VS register for simplification of the circuitry.

The characteristics of this architecture is that, when an input address signal is received, the signal is compared by the comparator 620 against the content of the RS register 602. If matched, the comparator 620 outputs a first selection signal to the multiplexer module 612 causing the multiplexer module 612 to transfer the content of the VS register 604 to the decoder 650; otherwise if unmatched, the comparator 620 outputs a second selection signal to the multiplexer module 612 causing the multiplexer module 612 to transfer the contents of the address buffers 614, 616, 618, i.e., the 3-bit segment access code (PA21, PA20, PA19) in the input address signal to the decoder 650.

An example will be used to depict the foregoing access operation. Assume both the FS register 606 and the VS register 604 currently store (1, 1, 1) and the RS register 602 currently stores (1, 1, 0), then if (PA21, PA20, PA19)=(1, 1, 1), the access will be directed to the flash memory's storage space 508 regardless of the content of the RS register 602. However, if the value of (PA21, PA20, PA19) is different from the content of the FS register 606, the segment to be accessed is dependent on the content of the RS register 602. If the content of the RS register 602 is (1, 1, 1) and (PA21, PA20, PA19)=(1, 1, 0), then the access is directed to the Mask ROM's storage area 606. However, if the content of RS register 602 is (1, 1, 0) and (PA21, PA20, PA19)=(1, 1, 0), then the access is directed to the Mask ROM's virtual segment 507. The following table shows the logic relationship between the input address, the content of the VS register 604, the content of the RS register 602, and the data received by the decoder 650.

TABLE

| | VS Register | | |
|---|---|---|---|
| | & FS | RS | |
| Input Address | Register | Register | Decoder |
| 0-6 | 7 | 7 | 0-6 (Mask ROM) |
| 7 | 7 | 7 | 7 (Flash Memory) |
| 0-5 | 7 | 6 | 0-5 (Mask ROM) |
| 6 | 7 | 6 | 7 (Mask ROM) |
| 7 | 7 | 6 | 7 (Flash Memory) |

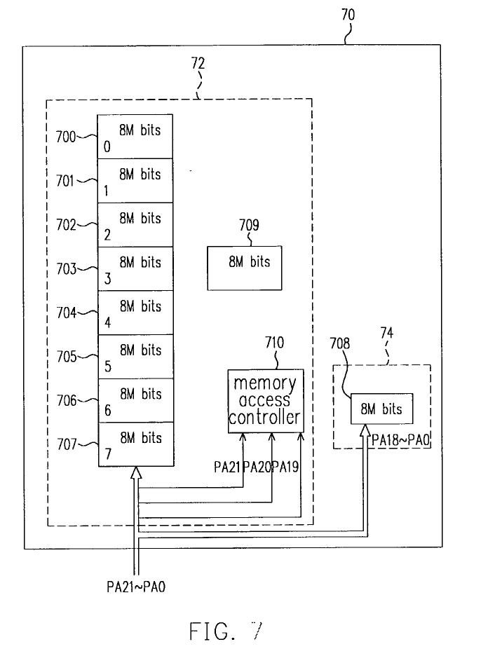

FIG. 7 is a schematic diagram showing still another example of the implementation of the multi-memory architecture according to the invention (which is here designated by the reference numeral 70). As shown, this multi-memory architecture 70 provides an accessible data storage capacity of 64 Mb, which is composed of a 72 Mb Mask ROM 72, an 8 Mb flash memory 74, and a controller 710. The characteristics of this multi-memory architecture 70 is that the flash memory 708 can be used to replace anyone of the segments (such as 707), and the replaced storage 707 can be further used to replace anyone of the segments 700-706. In addition, the segment 709 can be used to swap with anyone of the segments other than the one that is replaced by the segment 707.

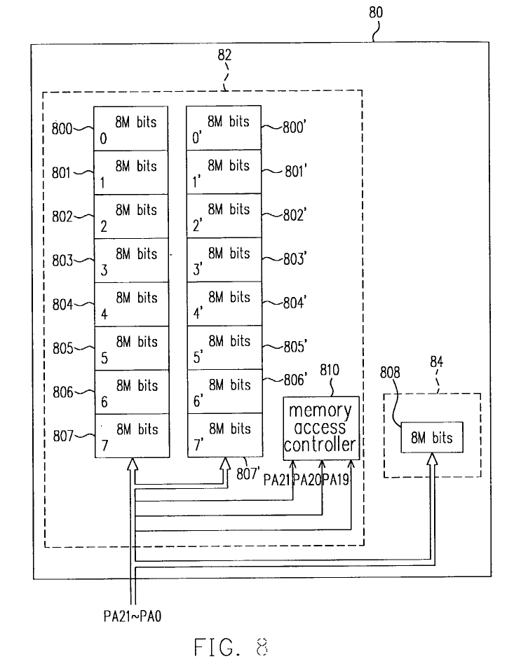

FIG. 8 is a circuit diagram showing another example of the implementation of the multi-memory architecture according to the invention (which is here designated by the reference numeral 80). As shown, this multi-memory architecture 80 provides an accessible data storage capacity of 64 Mb, which is composed of a 128 Mb Mask ROM 82, an 8 Mb flash memory 84, and a memory access controller 810. The characteristics of this multi-memory architecture 80 is that the flash memory's storage space 808 can be used to replace anyone of the segments (such as 807), and an additional replacement memory area composed of a plurality of replacement segments 800′-807′ is provided for swapping with the segments 800-807. Moreover, the flash memory's storage space 808 can be used to replace the segment 807′. After swapping, the segment 807′, after being replaced by the flash memory's storage space 808, can be further used to replace any one of the segments 800′-806′.

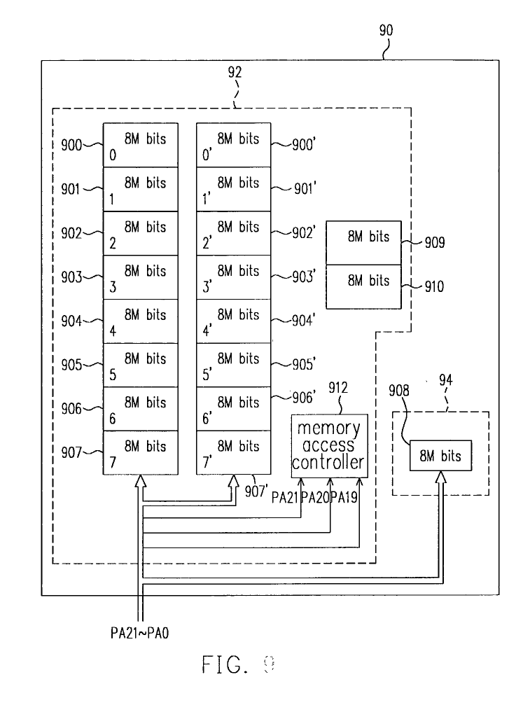

FIG. 9 is a circuit diagram showing still another example of the implementation of the multi-memory architecture according to the invention (which is here designated by the reference numeral 90). As shown, this multi-memory architecture 90 provides an accessible data storage capacity of 64 Mb, which is composed of a 144 Mb Mask ROM 92, an 8 Mb flash memory 94, and a memory access controller 912. The characteristics of this multi-memory architecture 90 is that the flash memory's storage space 908 can be used to replace anyone of the segments 900-907, and an additional replacement memory area composed of a plurality of replacement segments 900′-907′ is provided for swapping with the segments 900-907. Moreover, the flash memory's storage space 908 can be used to replace any one of the segments 900′-907′; and after swapping, the segment 907′, after being replaced by the flash memory's storage space 908, can be further used to replace any one of the segments 900′-906′. In addition, the multi-memory architecture 90 further includes a second replacement memory area composed of a plurality of replacement segments 909 and 910 for swapping with the segments other than those segments that are replaced by the segment 907″.

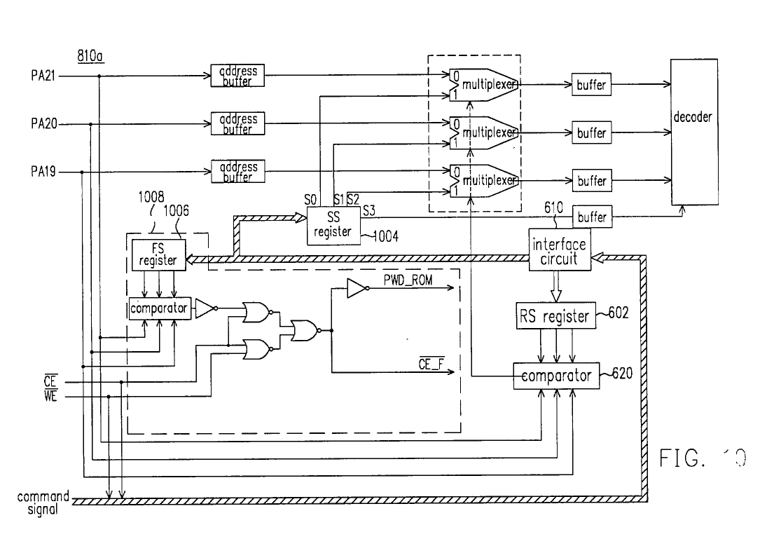

FIG. 10 is a circuit diagram showing an example of a memory access controller that is used for accessing control to any one of the multi-memory architectures respectively shown in FIG. 7, FIG. 8, and FIG. 9. Since the same controller circuitry is used for the access control to the multi-memory architectures respectively shown in FIG. 7, FIG. 8, and FIG. 9, the following description will use the case of FIG. 8 as example. The circuit part of the controller that is designated by the reference numeral 1008 is identical in function and architecture as the one shown in FIG. 4. The memory access controller 810a shown in FIG. 10 differs from the memory access controller 510a shown in FIG. 6 particularly in the SS (Swap Segment) register 1004, which includes two portions (S0-S2) and (S3) that are respectively used to store two pieces of information: (S0-S2) is used for storing the most significant 3 bits of the address of the segment that is currently being replaced by the flash memory, and (S3) is used for storing the reference number of the replacement memory area that is currently being used to replace the segments 800-807. Furthermore, S3 can also be used to connect decoder for selecting NROM 92 or Flash 94 and can be used to connect controller 1008 (not shown) for selecting NROM 92 or Flash 94. It is to be noted that since the Mask ROM 92 shown in FIG. 9 contains 18 segments, which is greater than the maximum number of 16 selectable by the SS register 1004 shown in FIG. 10, the SS register 1004 requires one more bit to be added in order to satisfy the circuit of FIG. 9. Therefore, in order to use more Mask ROMs, the corresponding number of bits need to be added to the SS register 1004.

This circuit operates substantially in the same manner as the one shown in FIG. 6. In the case in FIG. 8, the following table shows the logic relationship between the input address, the values of (S0-S2) and (S3), and the data received by the decoder. Note that in this table, assume that the content of the FS register 1006 is 7; S3=0 indicates the selection of the Mask ROM (i.e., the segments 800-807, denoted in the table by L.B.), and S3=1 indicates the selection of the replacement memory area (i.e., the replacement segments 800′-807′, denoted in the table by H.B).

TABLE

| | | | RS | |
|---|---|---|---|---|
| Input Address | S3 | S2-S0 | Register | Decoder |
| 0-6 | 0 | 7 | 7 | L.B. 0-6 |
| 7 | 0 | 7 | 7 | 7 (Flash Memory) |
| 0-5 | 0 | 7 | 6 | L.B. 0-5 |
| 6 | 0 | 7 | 6 | L.B. 7 |
| 7 | 0 | 7 | 6 | 7 (Flash Memory) |
| 0-6 | 1 | 7 | 7 | H B 0-6 |
| 7 | 1 | 7 | 7 | 7 (Flash Memory) |
| 0-5 | 1 | 7 | 6 | H B. 0-5 |
| 6 | 1 | 7 | 6 | H B 7 |
| 7 | 1 | 7 | 6 | 7 (Flash Memory) |

In conclusion, the multi-memory architecture according to the invention has the following advantages.

First, the multi-memory architecture of the invention is composed of two different types of memory devices such as a Mask ROM and a flash memory but the overall pin configuration is the same as one of the memory devices such as the flash memory. As a result, the package of the multi-memory architecture eliminates compatibility problem and existing PCB layout design scheme can be retained.

Second, the multi-memory architecture according to the invention allows its two memory devices such as Mask ROM and flash memory to share the same control buses and power buses so that they can be controlled through existing software codes without having to be rewritten.

Third, the multi-memory architecture according to the invention allows flexibility in design, which allows the included memory devices to be flexibly arranged in the desired manner for various applications.

Fourth, the multi-memory architecture according to the invention can be used to incorporate different types of memory devices in the same package for various applications.

It is to be noted that in the preferred embodiments disclosed above, although the multi-memory architecture of the invention is composed of a Mask ROM and a flash memory, the invention is not limited to this combination; and instead, the two memory devices included in the multi-memory architecture of the invention can be any kind of memory devices, such as Mask ROM, flash memory, SDRAM, and so on. Moreover, the FS register, RS register, and SS register in the multi-memory architecture of the invention are not limited to the storage of 3-bit address data but instead can be any other number of bits that are specified for gaining access to the intended segments in the two memory devices in the multi-memory architecture of the invention. This broad definition also applies to the comparators and multiplexers used in the multi-memory architecture of the invention.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. A multi-memory architecture with an externally accessible storage capacity known as a total memory capacity and the number of pins of the multi-memory architecture having the total memory capacity is known as a total pin number, wherein the total pin number comprises used and unused pins, the multi-memory architecture comprising: a first memory device having a first data storage capacity and a first predefined pin configuration having a first number of pins which is the actual number of used pins according to the first data storage capacity; and
a second memory device having a second data storage capacity and a second predefined pin configuration having a second number of pins which is the actual number of pins according to the second data storage capacity; wherein the first number of pins is greater than the second number of pins, and the total number of pins of the multi-memory architecture is not less than the number of pins of the first memory device of multi-memory architecture having the total memory capacity.

2. The multi-memory architecture of claim 1, wherein the externally-accessible total data storage capacity of the multi-memory architecture is equal to the data storage capacity of the first memory device plus the data storage capacity of the second memory device.

3. The multi-memory architecture of claim 1, wherein the second memory device comprises a plurality of segments and each segment has a data storage capacity equal to the data storage capacity of the first memory device; wherein the storage space of the first memory device is used to replace one of the segments in the second memory device so that an access to the replaced segment is mapped to the storage space of the first memory device.

4. The multi-memory architecture of claim 3, wherein the segment in the second memory device that is currently being replaced by the first memory device is used to replace any one of the segments in the second memory device other than the one currently being replaced by the first memory device.

5. The multi-memory architecture of claim 3, further comprising: at least one replacement segment in the second memory device, whose data storage capacity equals to each segment in the second memory device is used to replace any one of the segments in the second memory device other than the one being currently replaced by the first memory device.

6. The multi-memory architecture of claim 1, further comprising a replacement memory area, whose data storage capacity equals to the second memory device, which is partitioned into a plurality of segments each being equal in data storage capacity to the first memory device; the replacement memory area is used to replace the second memory device to allow the externally-accessible total storage space of the multi-memory architecture to cover the currently-accessed memory device selected from the second memory device, the replacement memory area excluding the storage space of the segment currently being replaced by the first memory device, and the first memory device in some segments of the currently-accessed memory.

7. The multi-memory architecture of claim 6, wherein the segment currently being replaced by the first segment is replaced by any one of the segments in the currently-accessed memory device other than the one being currently replaced by the first memory device.

8. The multi-memory architecture of claim 6, wherein the second memory device further comprising a plurality of second memory replacement segments, each being equal in data storage capacity to each segment in the currently-accessed memory device, which is used to replace any one of the segments in the currently-accessed memory device other than the segment currently being replaced by the first memory device.

9. The multi-memory architecture of claim 1, wherein the pin configuration of the first memory device having a total data capacity which is the sum of the first and second data capacities.

10. A multi-memory architecture comprising:
a first memory device having a first data storage capacity; and
a second memory device having a second data storage capacity;
wherein
an overall pin configuration of the multi-memory architecture is compatible with the pin configuration of the first memory device having the second data storage capacity.

11. The multi-memory architecture of claim 10, wherein the externally-accessible total data storage capacity of the multi-memory architecture is equal to the data storage capacity of the first memory device plus the data storage capacity of the second memory device.

12. The multi-memory architecture of claim 10, wherein the second memory device includes a plurality of segments and each segment comprises a data storage capacity equal to the data storage capacity of the first memory device; wherein the storage space of the first memory device is used to replace one of the segments in the second memory device so that an access to the replaced segment is mapped to the storage space of the first memory device.

13. The multi-memory architecture of claim 12, wherein the segment in the second memory device that is currently being replaced by the first memory device is used to replace any one of the segments in the second memory device other than the one currently being replaced by the first memory device.

14. The multi-memory architecture of claim 12, further comprising: at least one replacement segment in the second memory device, whose data storage capacity equals to each segment in the second memory device, which can be used to replace any one of the segments in the second memory device other than the one being currently replaced by the first memory device.

15. The multi-memory architecture of claim 10, further comprising a replacement memory area, whose data storage capacity equals to the second memory device, which is partitioned into a plurality of segments each being equal in data storage capacity to the first memory device; the replacement memory area is used to replace the second memory device to allow the externally-accessible total storage space of the multi-memory architecture to cover the currently-accessed memory device selected from the second memory device and the replacement memory area excluding the storage space of the segment currently being replaced by the first memory device, and the first memory device in some segments of the currently-accessed memory.

16. The multi-memory architecture of claim 15, wherein the segment currently being replaced by the first segment is replaced by any one of the segments in the currently-accessed memory device other than the segment being currently replaced by the first memory device.

17. The multi-memory architecture of claim 15, wherein the second memory device further includes a plurality of second memory replacement segments, each being equal in data storage capacity to each segment in the currently-accessed memory device, which is used to replace any one of the segments in the currently-accessed memory device other than the segment currently being replaced by the first memory device.

18. The multi-memory architecture of claim 10, wherein the pin configuration of the first memory device having a total data capacity which is the sum of the first and second data capacities.

19. A memory access controller for use in the multi-memory architecture composed of a first memory device and a second memory device comprising;
a segment identification unit, which is capable of generating a memory-access control signal in response to an input address signal;
a command identification unit, which is capable of generating a memory-mode signal in response to an input control signal; and
a memory selection unit, which is used to select between the two memory devices in the multi-memory architecture based on the memory-access control signal and the memory-mode signal.

20. The memory access controller of claim 19, wherein the segment identification unit includes:
a first memory address register for the first memory device, which is used to store a set of data representative of the address of the first memory device; and
a first comparator, which is capable of comparing an input address signal against the content of the first memory address register to thereby generate the memory-access control signal.

21. The memory access controller of claim 19, further comprising:
a replaced-segment register, which is used to store the address of the segment in the second memory device of the segment of the second memory device that is to be replaced by the first memory device;
a second comparator, which is capable of comparing the input address signal against the content of the replaced-segment register; if matched, the second comparator outputs an enable signal;
a virtual-segment register, which is used to store the address of the first memory device; and
a multiplexer module, which is under selection control by the enable signal output from the second comparator for selectively transferring either the content of the virtual-segment register or the segment access code in the input address signal to a decoder.

22. The memory access controller of claim 21, further comprising an interface circuit coupled to the first memory address register, the replaced-segment register, and the virtual-segment register for altering the content of a selected register therefrom.

23. The memory access controller of claim 21, further comprising a group of address buffers for storing the segment access code for identification of the address of the first memory device in the input address signal.

24. The memory access controller of claim 1 9, further comprising:
a replaced-segment register, which is used to store the address data indicating the segment in the second memory device that is currently being replaced by the first memory device;
a second comparator, which is capable of comparing the input address signal against the content of the replaced-segment register; if matched, the second comparator outputs an enable signal;
a swap-segment register, which is used to store the address of the address of the first memory device and a tag of a replacement memory area being swapped to replace the second memory device; and
a multiplexer module, which is under selection control by the enable signal output from the second comparator for selectively transferring either the content of the swap-segment register or the segment access code in the input address signal to a decoder.

25. The memory access controller of claim 24, further comprising an interface circuit coupled to the first memory address register, the replaced-segment register, and the swap-segment register for altering the content of a selected one therefrom.

26. The memory access controller of claim 24, further comprising a group of address buffers for storing the segment access code for identification of the address of the first memory device in the input address signal.
